(19) United States
(12) Patent Application Publication
(10) Pub. No.: US 2024/0209161 A1
(43) Pub. Date: Jun. 27, 2024

(54) SOLUTION OF POLYMER P IN N-TERT-BUTYL-2-PYRROLIDIONE FOR THE USE OF MEMBRANES

(71) Applicant: BASF SE, Ludwigshafen am Rhein (DE)

(72) Inventors: Oliver GRONWALD, Ludwigshafen (DE); Radosiaw Kierat, Ludwigshafen (DE); Tatjana Huber, Ludwigshafen (DE)

(73) Assignee: BASF SE, Ludwigshafen am Rhein (DE)

(21) Appl. No.: 18/554,131

(22) PCT Filed: Mar. 28, 2022
(86) PCT No.: PCT/EP2022/058053

§ 371 Date: Oct. 5, 2023

(30) Foreign Application Priority Data
Apr. 8, 2021 (EP) 21167355.3

(51) Int. Cl. C08J 3/09; C08J 5/18; C08K 5/05; C08L 27/16

(52) U.S. Cl. CPC C08J 3/096; C08J 5/18; C08K 5/05; C08L 27/16; C08J 2327/16; C08J 2439/06; C08J 2471/02

(57) ABSTRACT

A solution contains at least one polymer P, at least one water soluble polymer, and N-tert-butyl-2-pyrrolidone A corresponding process of making a membrane and the use of this membrane for water treatment are also provided.

The present invention relates to a solution comprising at least one polymer P, at least one water soluble polymer and N-tert-butyl-2-pyrrolidone, the process of making a membrane and the use of this membrane for water treatment.

Polyvinylidene fluoride (PVDF), ethylene chlorotrifluoroethylene (ECTFE), polyacrylonitrile (PAN), poly(acrylonitril-co-acrylicacidmethylester), polyimide resins (PI), regenerated cellulose and cellulose acetate (CA) are high performance polymers which are used in a variety of technical applications because of their mechanical properties and their chemical and thermal stability.

One major technical application is the use of partially fluorinated polymers and polyimide resins such as PVDF, ECTFE and PI as raw materials for the production of membranes, for example ultrafiltration membranes (UF membranes) and microfiltration membranes. Membranes for hemidialysis applications are manufactured from polyacrylonitrile (PAN), poly(acrylonitril-co-acrylicacidmethylester) and regenerated cellulose and cellulose acetate (CA). For all these porous membranes it is necessary to produce them in polar solvents which show lower or no toxical potential compared to the standard polar solvents like N-methyl-2-pyrrolidon (NMP), N,N-dimethylacetamide (DMAc) and N, N-dimethylformamide (DMF) combined with the same or better physical properties as the polar state of the art solvents. The process of producing membranes includes dissolving the polymers in a solvent, coagulating the polymer from such solvent (non-solvent induced phase separation) and further post-treatment steps. Within another process, the polymer is dissolved at elevated temperatures and subsequently cooled down to induce the phase separation and membrane formation process (temperature induced phase separation). The selection of the solvent is essential to the process and has impact on the properties of the obtained membrane, including but not limited to the membranes' mechanical stability, water permeability and size of pores.

EP-A 2804940 describes the use of N-alkyl-2-pyrrolidone such as N-tert-butyl-2-pyrrolidone as non-reprotoxic solvent for the polymer production of different kind of polymers such as polyvinylpyrrolidons. The use of N-tert-butyl-2-pyrrolidone (TBP) as solvent in a solution comprising a polymer P and a water soluble polymer for making a membrane with better separation performance combined with a higher stability but comparable water permeability of the resulting membranes and no toxicological potential is not disclosed.

In EP-A 20210689.4 the use of N-tert-butyl-2-pyrrolidone (TBP) as solvent for the preparation of sulfone polymer solutions which are used for the production of membranes with standard or even higher quality is described. The use of polymer P selected from the group of polyvinylidene fluoride (PVDF), ethylene chlorotrifluoroethylene (ECTFE), polyacrylonitrile (PAN), poly(acrylonitril-co-acrylicacidmethylester), polyimide resins (PI), regenerated cellulose and cellulose acetate (CA) which produce solutions with TBP that have higher viscosities and therefore allow formation of membranes with better separation performance combined with a higher stability but comparable water permeability are not disclosed.

It was an object of the present invention to provide an alternative solvent for poly vinylidene fluoride (PVDF), ethylene chlorotrifluoroethylene (ECTFE), polyacrylonitrile (PAN), poly(acrylonitril-co-acrylicacidmethylester), polyimide resins (PI), regenerated cellulose and cellulose acetate (CA) and for the process of making membranes. The alternative solvent should fulfill the requirements listed above.

Accordingly, the solution as defined above and a process for the making of membranes have been found.

To the polymer P

The solution comprises a polymer P selected from the group of poly vinylidene fluoride (PVDF), ethylene chlorotrifluoroethylene (ECTFE), polyacrylonitrile (PAN), poly(acrylonitril-co-acrylicacidmethylester), polyimide resins (PI), regenerated cellulose and cellulose acetate (CA). Sulfone polymers such as polysulfone, polyethersulfone and polyphenylsulfone are disclaimed by the definition of polymer P. A solution comprising the above-mentioned polymer P and sulfone polymers such as polysulfone, polyethersulfone and polyphenylsulfone are also disclaimed in this invention.

PVDF are polymers with a repeating unit of —[CH₂—CF₂]ₙ— with n from 4600 to 11000 with a high chemical stability. ECTFE is also like PVDF a partially fluorinated polymer with a repeating unit of —[CF₂—CFCl—CH₂—CH₂]ₙ— with n from 3000 to 10000 which provide high chemical resistance. Globally 60% of all membranes for water filtration are based on partially fluorinated polymers such as polyvinylidene fluoride (PVDF). The polyvinylidene fluoride which are usable for the invention can be used in different forms. Preferable are PVDF grades in powder and pellet form. These PVDF grades are applicable in the invention as linear or gel-free products with weight average molecular weights Mw in the range from 250-320 kDa (Solef® 6010), 380-400 kDa (Solef® 6012), 570-600 kDa (Solef® 1015) and 670-700 kDa (Solef® 6020) available from Solvay Speciality Polymers. ECTFE is available with a melt flow index of 1.0 (tested at 2.16 kg and 5.0 kg as Halar® 901 and 902 from Solvay Speciality Polymers.

PAN are polymers with repeating units of —[CH₂—CH(CN)]ₙ— with n from 700 to 3600 which are often used for the production of ultrafiltration and hemodialyzer membranes. For patients suffering from acute dialyzer reactions on dialyzers containing membranes belonging to the polyarylsulfone family (polysulfone/polyethersulfone) PAN dialyzers present an alternative. PAN based dialyzer modules are available for example from Gambro (Nephral ST400, Nephral ST400). For technical applications PAN membranes have good chemical stabilities and can be welded by heat or ultrasound. This makes the production of membrane envelopes possible, which are used in several filtration module types like Amafiter PM and Rochem FM. Today the membranes are commercially available and used in several applications such as water treatment, concentration of whey or protein and concentration of oil/water mixtures. Poly(acrylonitril-co-acrylicacidmethylester) are polymers with repeating units of —[CH₂—CH(CN)]—[CH₂—CH(COOCH₃)]ₖ— with n+k from 800 to 2600 and n/k ratio from 91:9 to 99:1. Poly(acrylonitril-co-acrylicacidmethylester) may be used to fabricate multilayer mixed matrix membranes (MMMMs) for easy separation of ethanol from an ethanol-water mixture.

Pl are polyimide resins with a repeating unit of [—R¹CO—NR²—CR³O]ₙ— with n from 100 to 300 and with R¹, R² and R³ representing 3,3′,4,4′-benzophenonetetracarboxylic dianhydride and dia-minophenylindane as building blocks with inherent viscosity from 0.5 to 0.8 dl/g and weight average molecular weight of 80 kDa (Matrimid® 5218, Huntsman Corporation, Salt Lake City, USA).

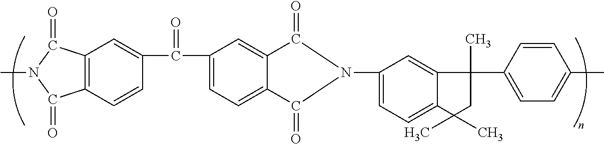

### Matrimid 5218

PI resins constitute ultrafiltration membranes with excellent thermal and chemical resistance.

Regenerated cellulose and cellulose acetate (CA) membranes combine high flow rates and thermal stability with very low adsorption due to their hydrophilicity. Cellulose and cellulose acetate (CA) membranes are used for medical membranes. For patients suffering from acute dialyzer reactions on dialyzers containing membranes belonging to the polyarylsulfone family (polysulfone/polyethersulfone) cellulose di- or triacetate dialyzers present an alternative. Cellulose diacetate-based dialyzer modules are available for example from Baxter (Dicea 170) and cellulose triacetate from Nippon Nipro (FB 170-U). Ultrafiltration membranes based on regenerated cellulose are available from Millipore (Ultracel® PL-TK and RC).

### To the Water-Soluble Polymers

The water-soluble polymer helps to adjust the viscosity of the solution. The main purpose of the water solution polymer is to support the formation of the pores. In the coagulation step during the process of making the membrane the water-soluble polymer becomes distributed in the coagulated membrane and thus becomes the place holder for pores.

The water-soluble polymer may be any known water-soluble polymer selected from the group of polyvinyl pyrrolidone and polyalkylene oxides with a molar mass of 8000 g/mol or higher. Preferred water-soluble polymers are selected from the group of polyvinyl pyrrolidone, polyethylene oxide, polypropylene oxide, polyethylene oxide/polypropylene oxide block copolymers and mixtures thereof. A very preferred water-soluble polymer is polyvinyl pyrrolidone.

### To the Solution

The solution may comprise further additives. These additives are selected from the group of C₂-C₄ alkanol, C₂-C₄ alkanediol, C₃-C₄ alkanetriol, polyethylene glycol with a molar mass in the range of 100 to 1000 g/mol and mixtures of those. Preferred additives are ethanol, n-propanol, iso-propanol, n-butanol, iso-butanol, tert-butanol, ethylene glycol, 1,1-ethandiol, 1,2-propandiol, 1,3-propandiol, 2,2-propandiol, 1,2,3-propantriol, 1,1,1-propantriol, 1,1,2-propantriol, 1,2,2-propantriol, 1,1,3-propantriol, 1,1,1-butantriol, 1,1,2-butantriol, 1,1,3-butantriol, 1,1,4-butantriol, 1,2,2,-butantriol, 2,2,3-butantriol, 2-methyl-1, 1,1-triolpropan, 2-methyl-1,1,2-triolpropan, 2-methyl-1,2,3-triolpropan, 2-methyl-1,1,3-triol-propan.

In a preferred embodiment up to 25 wt.-%, in particular up to 20 wt. %, based on the solution is an additive.

In a more preferred embodiment, the amount of additive is in the range of 0.1 to 16 wt. %, in particular 5 to 16 wt.-% based on the solution.

The solution may comprise further solvents besides the N-tert-butyl-2-pyrrolidone, hereinafter referred to as co-solvents.

Preferred are co-solvents that are miscible with the N-tert-butyl-2-pyrrolidone in any ratio. Suitable co-solvents are, for example, selected from high-boiling ethers, esters, ketones, asymmetrically halogenated hydrocarbons, anisole, dimethylformamide, dimethyl sulfoxide, sulfolane, N-methyl-2-pyrrolidone, N-ethyl-2-pyrrolidone, N-n-propyl-2-pyrrolidone, N-iso-proypyl-2-pyrrolidone, N-n-butyl-2-pyrrolidone, N, N-dimethyl-2-hydroxypropanoic amide and N, N-diethyl-2-hydroxypropanoic amide.

In a preferred embodiment at least 10% by weight, in particular at least 90% by weight of the total amount of all solvents of the solution is N-tert-butyl-2-pyrrolidone.

In a most preferred embodiment no co-solvent is used in the solution and N-tert-butyl-2-pyrrolidine is the only solvent used.

In a most preferred embodiment the solution comprises 5 to 50 parts by weight, in particular 10 to 40 parts by weight, more preferably 20 to 30 parts by weight of polymer P per 100 parts by weight of the total amount of N-tert-butyl-pyrrolidone.

Preferably, the solution comprises 1 to 40 wt.-%, in particular 10 to 30 wt.-%, more preferably 15 to 25 wt.-% of polymer P according to the solution.

In a most preferred embodiment the solution comprises 0.1 to 25 wt.-%, in particular 1 to 20 wt.-%, more preferably 10 to 20 wt.-% of water soluble polymers according to the solution.

The solution may be prepared by adding the polymer P and the water-soluble polymer to the N-tert-butyl-2-pyrrolidone and dissolving the polymer P according to any process known in the art. The dissolution process may be supported by increasing the temperature of the solution and/or by mechanical operations like stirring. In an alternative embodiment the polymer P may be already synthesized in N-tert-butyl-2-pyrrolidine or a solvent mixture comprising N-tert-butyl-2-pyrrolidine.

### To the Process of Making a Membrane

In the context of this application a membrane shall be understood to be a semipermeable structure capable of separating two fluids or separating molecular and/or ionic components or particles from a liquid. A membrane acts as a selective barrier, allowing some particles, substances or chemicals to pass through, while retaining others. The membrane may have various geometries such as flat sheet, spiral wound, pillows, tubular, single bore hollow fiber or multiple bore hollow fiber.

For example, membranes can be reverse osmosis (RO) membranes, forward osmosis (FO) membranes, nanofiltration (NF) membranes, ultrafiltration (UF) membranes or microfiltration (MF) membranes. These membrane types are generally known in the art and are in detail described in literature. A good overview is found also in earlier European patent application No. 15185604.4 (PF 78652) which is here with incorporated herein by reference. A preferred membrane is the ultrafiltration (UF) membrane.

Membranes may be produced according to a process comprising the following steps:
a) providing a solution comprising a polymer P, N-tert-butyl-2-pyrrolidine and further comprising a water-soluble polymer,
b) contacting the solution with a coagulant
c) optionally oxidizing and washing the obtained membrane.

The solution in step a) corresponds to the solution described above. The water soluble polymer helps to adjust the viscosity of the solution. The main purpose of the water solution polymer is to support the formation of the pores. In the following coagulation step b) the water soluble polymer becomes distributed in the coagulated membrane and thus becomes the place holder for pores.

The water-soluble polymer may be any known water soluble polymer. Preferred water soluble polymers are selected from the group of polyvinyl pyrrolidone and polyalkylene oxide with a molar mass of 8000 g/mol or higher like polyethylene oxide, polypropylene oxide, polyethyleneoxide/polypropylene oxide block copolymers and mixtures thereof. A very preferred water soluble polymer is polyvinyl pyrrolidone.

In a preferred embodiment, the solution in step a) comprises 75 to 90 wt.-% of the polymer P and 10 to 25 wt.-% of the water-soluble polymer, based on the total weight of the polymer P and water soluble polymer.

Preferably, the solution comprises 80 to 90 wt.-% of the polymer P and 10 to 20 wt.-% of the water soluble polymer based on the total weight of the polymer P and water soluble polymer.

The solution may optionally be degassed before proceeding to the next step.

In step b) the solution is contacted with a coagulant. In this step coagulation of the polymer P occurs and the membrane structure is formed.

The polymer P should have low solubility in the coagulant. Suitable coagulants are, for example, liquid water, water vapor, alcohols or mixtures thereof.

Suitable alcohols are, for example, mono-, di- or trialkanols selected from the group of the group of C₂-C₄ alkanol, C₂-C₄ alkanediol, C₃-C₄ alkanetriol, polyethylene oxide with a molar mass of 100 to 1000 g/mol as they can be used as additives in the inventive solution. Preferred mixtures of the coagulants are mixtures comprising liquid water and alcohols, more preferably are mixtures comprising liquid water and the alcohols that were optionally used as additive in the inventive solution. A preferred coagulant is liquid water.

Further details of process steps a) and b) depend on the desired geometrical structure of the membrane and the scale of production, which includes lab scale or commercial scale.

For a flat sheet membrane detailed process steps a) and b) could be as follows:
a1) adding the water-soluble polymer to the solution comprising a polymer P and N-tert-butyl-2-pyrrolidine
a2) heating the solution until a viscous solution is obtained; typically the solution is kept at a temperature of 20 to 100° C., preferably 40 to 80° C., more preferably 50 to 60° C.
a3) further stirring of the solution until a homogenous mixture is formed; typically ho-mogenization is finalized within 5 to 10 h, preferably within 1 to 2 hours
b1) Casting the solution obtained in a3) on a support and thereafter transferring the casted film into a coagulation bath, which is preferably water.

For the production of single bore hollow fiber or multiple bore hollow fibers step b1) may performed by extruding the solution obtained in a3) through an extrusion nozzle with the required number of hollow needles. The coagulating liquid is injected through the hollow needles into the extruded polymer during extrusion, so that parallel continuous channels extending in extrusion direction are formed in the extruded polymer. Preferably the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent.

Further process step c) is optional. In a preferred embodiment process step c) is performed. Either the membrane is washed several times with water for 50-90° C. (step c1) or oxidation as well as washing is performed in order to remove the water-soluble polymer and to form the pores (step c2).

For oxidation any oxidant may be used. Preferred is a water-soluble oxidant such as in particular sodium hypochlorite.

According to the invention solutions of polymer P are obtained that show no or at least less turbidity. The solutions are suitably for the manufacturing of membranes. Membranes obtained have high mechanical stability and have excellent separation characteristics. In particular, membranes have better separation performance (lower MWCO) combined with a higher stability but comparable water permeability.

The membranes obtained by the process of the invention may be used for any separation purpose, for example water treatment applications, treatment of industrial or municipal waste-water, desalination of sea or brackish water, dialysis, plasmolysis, food processing.

### EXAMPLES

Abbreviations and compounds used in the examples:

| | |
|---|---|
| PWP | pure water permeation |
| MWCO | molecular weight cutoff |
| NTU | nephelometric turbidity unit |
| TBP | N-tert.-butyl-2-pyrrolidone |
| NMP | N-methyl-2-pyrrolidone |
| DMAc | N,N-dimethylacetamide |
| PVDF 1 | Polyvinylidenefluoride FR904 (Shanghai New |
| | Materials Co, Ltd. China) |
| PVDF 2 | Polyvinylidenefluoride Solef S 6010 (Solvay |
| | Specialty Polymers, USA.) |

| | |
|---|---|
| PVDF 1 | Polyvinylidenefluoride with a viscosity number (ISO 307, 1157, 1628; in |
| | 0.1 g/100 ml N-methyl-2-pyrrolidone) of 284.4 ml/g; a molecular weight |
| | Mw (GPC in DMAc + 0.5 wt % LiBr, PMMA-Standards, PSS Polymer |
| | Standards Service GmbH, Mainz, Germany, with molecular weights from |
| | M = 800 bis M = 2.200.000 g/mol): 471000 g/mol, Mw/Mn = 5.1 |
| PVDF 2 | Polyvinylidenefluoride with a viscosity number (ISO 307, 1157, 1628; in |
| | 0.1 g/100 ml N-methyl-2-pyrrolidone) of 171.5 ml/g; a molecular weight |
| | Mw (GPC in DMAc + 0.5 wt % LiBr, PMMA-Standards, PSS Polymer |
| | Standards Service GmbH, Mainz, Germany, with molecular weights from |
| | M = 800 bis M = 2.200.000 g/mol): 276000 g/mol, Mw/Mn = 2.2 |
| Luvitec ® K30 | Polyvinylpyrrolidone with a Mw of greater than 28000 g/mol and a solu- |
| | tion viscosity characterised by the K-value of 30, determined according |
| | to the method of Fikentscher (Fikentscher, Cellulosechemie 13, 1932 |
| | (58)) |
| Pluriol ® E 400 | Polyethylene oxide with an average molecular weight of 400 g/mol cal- |
| | culated from the OH numbers according to DIN 53240. |
| Polyox ® WSR-N 750 | Polyethyleneoxide with a solution viscosity characterised by the K-value |
| | of 109, determined according to the method of Fikentscher (Fikentscher, |
| | Cellulosechemie 13, 1932 (58)) and a molecular weight Mw (GPC in wa- |
| | ter, polyethyleneoxide standard): 456000 g/mol |

The polymer solution turbidity was measured with a turbidimeter 2100AN (Hach Lange GmbH, Düsseldorf, Germany) employing a filter of 860 nm and expressed in nephelometric turbidity units (NTU). Low NTU values are preferred.

The polymer solution viscosity was measured with a Brookfield Viscometer DV-I Prime (Brookfield Engineering Laboratories, Inc. Middleboro, USA) with RV 6 spindle at 60° C. with 20 to 100 rpm.

The pure water permeance (PWP) of the membranes was tested using a pressure cell with a diameter of 74 mm using ultrapure water (salt-free water, filtered by a Millipore UF-system) at 23° C. and 1 bar water pressure. The pure water permeation (PWP) is calculated as follows (equation 1):

$$PWP = \frac{m}{A \times P \times t} \qquad ( 1 )$$

PWP: pure water permeance [kg/bar h m²]
m: mass of permeated water [kg]
A: membrane area [m^{2]}
P: pressure [bar]
t: time of the permeation experiment [h].

A high PWP allows a high flow rate and is desired.

In a subsequent test, a solution of poly(ethylene oxide) (POLYOX® WSR-N 750, 0.1 wt % in ultrapure water) were used as feed to be filtered by the membrane at a pressure of 0.2 bar and retention (MWCO %) is calculated by equation (2) in which C_{F} and C_{P} represent the concentrations in initial feed and in permeate, respectively. For polyethylene oxide-standard (MWCO 1) the concentrations of the feed and permeate were determined by GPC-measurement (refractive index detector).

$$MWCO = ( 1 - \frac{{c}_{F}}{\text{?}} ) \times 100 [ \% ] \qquad ( 2 )$$

$$\text{?} \text{indicates text missing or illegible when filed}$$

According to Matsuyama et. al (Ind. Eng. Chem. Res. 2017, 56, 11302-11311, DOI: 10.1021/acs.iecr.7b02996) POLYOX® WSR-N 750 has a calculated stokes radius of 21.9 nm. A high MWCO of more than 75% indicates ultrafiltration capability and is desired.

Tensile testing was carried out according DIN Iso 527-3 and the membranes characterized with Emodulus (Emod in MPa) and strain at break (strain in %).

### Preparation of Membranes Using TBP as Polymer Solvent

### General Procedure

Into a three-neck flask equipped with a magnetic stirrer there were added 60 g of solvent S1, 20 g PVDF polymer, 3 g water soluble polymer polyvinylpyrrolidone (Luvitec® K30) and 15 g polyethylene oxide (Pluriol® E 400) as optional as given in table 2. The mixture was heated un-der gentle stirring at 60° C. until a homogeneous clear viscous solution, usually referred to as solution was obtained. The solution was degassed overnight at room temperature.

After that the membrane solution was reheated at 60° C. for 2 hours and casted onto a glass plate with a casting knife (300 microns) at 60° ° C. using an Erichsen Coating machine operating at a speed of 5 mm/min. The membrane film was allowed to rest for 30 seconds before immersion in a water-based coagulation bath at 25° C. for 10 minutes. After the membrane had detached from the glass plate, the membrane was carefully transferred into a water bath for 12 h. After-wards the membrane was washed with water at 60° C. three times.

Polymer solutions produced with TBP according to the invention show higher solution viscosity and membranes fabricated thereof showed improved mechanical stability (higher Emodulus) over membranes known from the art.

TABLE 1
Properties of polymer solutions (10 g PVDF,
90 g solvent S1), viscosity@60°
C. [Pas], turbidity@RT [NTU]

| | polymer | Solvent S1 | viscosity | turbidity |
|---|---|---|---|---|
| Ex 1 | PVDF 2 | TBP | 0.45 | 1.11 |
| Ex 2 | PVDF 1 | TBP | 1.30 | 2.53 |
| Comp ex 1 | PVDF 2 | NMP | 0.15 | 0.10 |
| Comp ex 2 | PVDF 1 | NMP | 0.74 | 52.8 |
| Comp ex 3 | PVDF 2 | DMAc | 0.06 | 0.09 |
| Comp ex 4 | PVDF 1 | DMAc | 0.36 | 1.51 |

TABLE 2
Properties of polymer solutions and membranes prepared thereof, Coagulation water-PEO400
(50/50 wt/wt), Posttreatment: water wash @ 60° C., Viscosity@60° C. [Pas],
turbidity@RT [NTU], MWCO in [kDa], PWP in [kg/h m²bar], Emodulus [MPa], Strain@break [%]

| | PVDF 1 | K30 | PEO400 | Solvent S1 | Visco | turbidity | PWP | MWCO | Emod | Strain@break |
|---|---|---|---|---|---|---|---|---|---|---|
| Ex 3 | 20 g | 4 g | 16 g | 60 g TBP | 56.7 | 10.8 | 1040 | 75.6 | 74.9 | 58.0 |
| Comp | 20 g | 4 g | 16 g | 60 g NMP | 32.3 | 11.2 | 1100 | 46.6 | 59.1 | 42.7 |
| ex 5 | | | | | | | | | | |
| Comp | 20 g | 4 g | 16 g | 60 g DMAc | 16.9 | 16.9 | 715 | 48.7 | 51.4 | 39.9 |
| ex 6 | | | | | | | | | | |

Membranes according to the invention are having a higher MWCO and elevated mechanical stability according to Emodulus and elongation at break.

1-12. (canceled)

13: A solution, comprising:
at least one polyvinylidene fluoride (PVDF) as polymer P,
at least one water soluble polymer selected from the group consisting of polyvinylpyrrolidone, a polyalkylene oxide with a molecular mass of 8,000 g/mol or higher, a polyethylene oxide/polypropylene oxide block copolymer, and mixtures thereof,
an additive selected from the group consisting of C₂-C₄ alkanol, C₂-C₄ alkanediol, C₃-C₄ alkanetriol, polyethylene oxide with a molar mass of 100 to 1,000 g/mol, and mixtures thereof, and
N-tert-butyl-2-pyrrolidone as the only solvent used,
wherein the solution comprises 10 to 30% by weight of the at least one polyvinylidene fluoride (PVDF) and 1 to 30% by weight of the additive, both based on a total weight amount of the solution.

14: A process for making a membrane, the process comprising:
making a membrane with the solution according to claim 13.

15: The process of claim 14, comprising the following:
a) providing the solution,
b) contacting the solution with at least one coagulant, and
c) optionally, washing or oxidizing and washing an obtained membrane.

16: The process according to claim 15, wherein the at least one coagulant comprises water or water vapor.

17: The solution according to claim 13, wherein the polyalkylene oxide with a molecular mass of 8.000 g/mol or higher is polyethylene oxide or polypropylene oxide.
